(19) United States
(12) Patent Application Publication
(10) Pub. No.: US 2024/0419504 A1
(43) Pub. Date: Dec. 19, 2024

(54) CAPACITY PREDICTION AND MANAGEMENT FOR VM DEPLOYMENT

(71) Applicant: Microsoft Technology Licensing, LLC, Redmond, WA (US)

(72) Inventors: Govind RAMASWAMY, Lynnwood, WA (US); Murali CHINTALAPATI, Bellevue, WA (US); Karkala Akarsh PRABHU, Hyderabad (IN); Chaitanya MUPPALA, Hyderabad (IN); Juhi BASKAR, Hyderabad (IN); Ashish MANGALAMPALLI, Hyderabad (IN); Igor FIGLIN, Redmond, WA (US); Anjalika MITRA, Sammamish, WA (US); Arun KISHAN, Kirkland, WA (US)

(21) Appl. No.: 18/336,789

(22) Filed: Jun. 16, 2023

(51) Int. Cl. G06F 9/50

(52) U.S. Cl. CPC G06F 9/505; G06F 9/5077

(57) ABSTRACT

Capacity prediction and management are provided for virtual machine (VM) deployment. A resource manager receives requests for VM allocation indicating a prioritized list of VM types (e.g., first, second, third priority) and provisions the requests with the second and/or third priority VM types if there is a capacity shortage of the first and/or second priority VM types. The resource manager may recommend available VMs of various priority VM types in the requested or other regions and/or zones. A capacity analyzer predicts future requests for VM creation, including a predicted compute capacity, timeframe(s), region(s), zone(s), etc., based on past VM creation. Entities may be alerted if predicted future compute capacity is less than, equal to, or greater than predicted compute capacity. The resource manager may reserve predicted compute capacity for predicted requests and may release the reserved capacity if the request is not received.

### BACKGROUND

A virtual machine (VM) is an emulated computer system that executes in the form of software on the operating system of a physical host computing device (the “host”). A VM may execute its own operating system (OS) upon which any number of applications may execute under VM control. Furthermore, multiple VMs may simultaneously execute on a single host. A hypervisor is an application that may be used to create and execute VMs. The hypervisor presents the VMs with a virtual operating platform and manages their execution. Some cloud computing platforms offer virtual machines to users (e.g., customers). The users may request the VMs under various pay structures (e.g., pay by subscription, by number of VMs requested, by VM time used, etc.) to execute user workloads (e.g., applications). In response to a user request, the cloud computing platform may deploy the requested VMs to servers where they may be utilized by the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein enable capacity prediction and management for virtual machine (VM) deployment. A resource manager receives requests by entities for VM allocation. Requests may include compute capacity parameter(s) indicating, for example, a number of VMs, one or more regions or zones within one or more regions, and a prioritized list of VM types indicating a first priority VM type, and other priority VM types (e.g., second, third, etc. priority VM types) as substitute or alternate VMs. The resource manager provisions the request for VM allocation with available VMs of the first priority VM type. If the resource manager determines a capacity shortage of VMs of the first priority VM type to fulfill the request for VM allocation, the resource manager may provision the request for VM allocation with available VMs of the second, third, etc. priority VM type(s).

The resource manager may notify an entity providing a request about the provisioning of the request, e.g., including a quantit(ies) of the first, second, third, etc. priority VM types available for provisioning for a workload. The resource manager may recommend (e.g., to an entity providing the request) about available VMs of the first, second, third, etc. priority VM types in other regions and/or zones (e.g., a second region or a second zone within the second region). The resource manager may recommend (e.g., to an entity providing the request) available VMs of other priorities not requested (e.g., a third priority VM type) in one or more requested or unrequested regions or zones. The requestor may accept or reject provisioning and/or recommendations.

The resource manager may interact with a capacity analyzer. A capacity analyzer (e.g., a machine learning predictor) may determine (e.g., learn) past (e.g., historical) VM creation by an entity, such as past compute capacity(ies) (e.g., VM quantity, VM type), timeframe(s), region(s), zone(s), etc. The capacity analyzer may predict a future request for VM creation by the entity, including a predicted compute capacity, a predicted timeframe, predicted region(s), predicted zone(s), etc., based on the entity's past VM creation. The capacity analyzer may predict a future compute capacity for one or more regions and/or zones within regions during the predicted timeframe and/or other timeframes. The capacity analyzer may alert the entity if the predicted future compute capacity is less than the predicted compute capacity. The capacity analyzer may alert the entity about a future timeframe when the predicted compute capacity is equal to or greater than the future compute capacity.

The resource manager may receive an indication that the entity participates in dynamic reservation of computing capacity for VM allocation. The resource manager may reserve the predicted compute capacity at the predicted timeframe before the resource manager receives the request for VM allocation. A reservation may be automatic based on a prediction by the capacity analyzer that the future compute capacity will be less than the predicted compute capacity without the reservation. The resource manager may provision a request for VM allocation (e.g., during the reserved timeframe) with available VMs (e.g., of the requested first or second priority VM types) from the reserved compute capacity. The resource manager may release the reserved predicted compute capacity at the predicted timeframe if the request for VM allocation is not received within a time threshold based on a start time of the predicted timeframe.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1A shows a block diagram of an example network-based computing system configured to enable capacity prediction and management for virtual machine (VM) deployment, in accordance with an embodiment.

FIG. 1B shows a block diagram of an example resource manager, in accordance with an embodiment.

FIG. 2 shows flowchart of a process for avoiding VM deployment failures by making and fulfilling VM requests from multiple types of VMs, in accordance with an embodiment.

FIG. 3 shows a flowchart of a process for avoiding VM deployment failures through VM capacity prediction, VM request prediction, and mitigation by notification, in accordance with an embodiment.

FIG. 4 shows a flowchart of a process for avoiding VM deployment failures through VM capacity prediction, VM request prediction, and mitigation by VM reservation, in accordance with an embodiment.

FIG. 5 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Virtualization involves simulated versions of computing device (e.g., machine) software or hardware components. Cloud computing platforms enable users (e.g., customers of cloud computing services) to access a shared pool of computing resources. A virtual machine (VM) is a digital version of a physical computing device. Virtual machine software can run programs and operating systems, store data, connect to networks, among other computing operations. A VM cloud service involves maintenance, such as updates to computing devices and system monitoring, to maintain computing resources for allocation to fulfill customer requests. For example, VM allocation instances may maintain a cache storing relevant information about computing device inventory, such as device temperatures, allocations, type (e.g., hardware details, such as CPU, memory), software, operating systems, location (e.g., region, zone), etc.

Cloud-based systems utilize compute resources to execute code, run applications, and/or run workloads. Examples of compute resources include, but are not limited to, VMs, VM scale sets, clusters (e.g., Kubernetes clusters), machine learning (ML) workspaces (e.g., a group of compute intensive VMs for training machine learning models and/or performing other graphics processing intensive tasks), serverless functions, and/or other compute resources of cloud computing platforms. Those types of resources are used by users (e.g., customers) to run code, applications, and workloads in cloud environments which they are billed for based on the usage, scale, and compute power the customer consume. A cloud service provider may implement or otherwise use a centralized mechanism (e.g., Azure® Resource Manager™ in Microsoft® Azure® or CloudTrail® in Amazon Web Services®) to monitor and control the creation and/or deployment of compute resources in the cloud computing platform.

Cloud computing customers (e.g., users, entities) may request VM creation in bulk to process workloads. An “entity” may be a user account, a subscription, a tenant, or another entity that is provided services of a cloud computing platform by a cloud service provider. A request may fail due to a lack of capacity. For example, a company may request deployment of thousands of VMs. Customers may request VM allocations to perform one or more tasks. Customers may provide detailed requests related to VMs, such as a selected number of VMs of one or more types, which may be identified by a stock keeping unit (SKU), redundancy, region, zone, security, etc. SKUs may group or categorize VMs (and, in some cases, their underlying compute hardware) into a variety of types, such as general purpose with a balanced CPU-to-memory ratio, compute optimized, high performance compute, memory optimized, storage optimized, graphic processing for graphic rendering and video editing, etc. Each VM type may further include multiple possible VM sizes that may further reflect their underlying compute hardware, including processor type, processing cores, processor speed, networking bandwidth, memory, etc. For instance, the

A VM deployment may be considered failed even if only one VM out of the group fails to be created or is degraded. Customers may request particular types of VMs in particular geographical regions and/or zones within regions to process workloads at particular timeframes. A deployment may fail even if only one requested VM type is not available for deployment. For example, a customer requesting deployment of 500 VMs of a first type in the East region of the USA may receive notice that deployment failed because only 490 VMs are available.

Embodiments described herein enable capacity prediction and management for VM deployment. A resource manager receives requests by entities for VM allocation. Requests may include compute capacity parameter(s) indicating, for example, a number of VMs, one or more regions (geographical), one or more zones (sub-regions) within one or more regions (e.g., a city within a state), and a prioritized list of VM types indicating a first priority VM type, and other priority VM types (e.g., second priority, third priority, and further priority VM types) as substitute or alternate VMs. The resource manager provisions the request for VM allocation with available VMs of the first priority VM type. If the resource manager determines a capacity shortage of VMs of the first priority VM type to fulfill the request for VM allocation, the resource manager may provision the request for VM allocation with available VMs of the second, third, etc. priority VM type(s).

The resource manager may notify an entity providing a request about the provisioning of the request, e.g., including a quantit(ies) of the first, second, third, etc. priority VM types available for provisioning for a workload. The resource manager may recommend (e.g., to an entity providing the request) about available VMs of the first, second, third, etc. priority VM types in other regions and/or zones (e.g., a second region or a second zone within the second region). The resource manager may recommend (e.g., to an entity providing the request) available VMs of other priorities not requested (e.g., a third priority VM type) in one or more requested or unrequested regions or zones. The requestor may accept or reject provisioning and/or recommendations.

The resource manager may interact with a capacity analyzer. A capacity analyzer (e.g., a machine learning predictor) may determine (e.g., learn) past (e.g., historical) VM creation by an entity, such as past compute capacity(ies) (e.g., VM quantity, VM type), timeframe(s), region(s), zone(s), etc. The capacity analyzer may predict a future request for VM creation by the entity, including a predicted compute capacity, a predicted timeframe, predicted region(s), predicted zone(s), etc., based on the entity's past VM creation. The capacity analyzer may predict a future compute capacity for one or more regions and/or zones within regions during the predicted timeframe and/or other timeframes. The capacity analyzer may alert the entity if the predicted future compute capacity is less than the predicted compute capacity. The capacity analyzer may alert the entity about a future timeframe when the predicted compute capacity is equal to or greater than the future compute capacity.

The resource manager may receive an indication that the entity participates in dynamic reservation of computing capacity for VM allocation. The resource manager may reserve the predicted compute capacity at the predicted timeframe before the resource manager receives the request for VM allocation. A reservation may be automatic based on a prediction by the capacity analyzer that the future compute capacity will be less than the predicted compute capacity without the reservation. The resource manager may provision a request for VM allocation (e.g., during the reserved timeframe) with available VMs (e.g., of the requested first or second priority VM types) from the reserved compute capacity. The resource manager may release the reserved predicted compute capacity at the predicted timeframe if the request for VM allocation is not received within a time threshold based on a start time of the predicted timeframe.

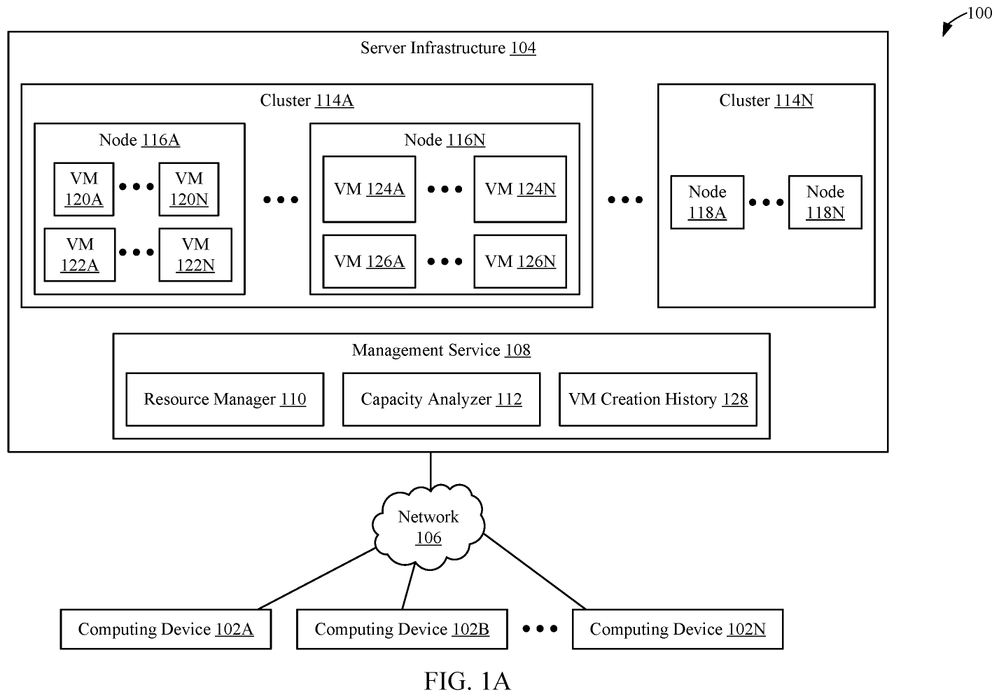

To help illustrate the aforementioned systems and methods, FIG. 1A will now be described. In particular, FIG. 1A shows a block diagram of an example network-based computing system 100 (“system 100” hereinafter) configured to enable capacity prediction and management for virtual machine (VM) deployment, in accordance with an embodiment. As shown in FIG. 1A, system 100 includes one or more computing devices 102A, 102B, and 102N (collectively referred to as “computing devices 102A-102N”) and a server infrastructure 104. Each of computing devices 102A-102N and server infrastructure 104 are communicatively coupled to each other via network 106. Network 106 may comprise one or more networks such as local area networks (LANs), wide area networks (WANs), enterprise networks, the Internet, etc., and may include one or more of wired and/or wireless portions.

Server infrastructure 104 may be a network-accessible set of computing devices referred to as a server set (e.g., a cloud-based environment or platform comprising a server inventory). A server inventory may be grouped geographically into regions and zones within regions. Servers may be organized, for example, as racks (e.g., groups of servers), clusters (e.g., groups of racks), data centers (e.g., groups of clusters), etc. As shown in FIG. 1A, server infrastructure 104 includes a management service 108 and one or more clusters 114A and 114N (collectively referred to as “clusters 114A-114N”). Each of clusters 114A-114N may comprise a group of one or more nodes (also referred to as compute nodes) and/or a group of one or more storage nodes. For example, as shown in FIG. 1A, cluster 114A includes nodes 116A-116N and cluster 114N includes nodes 118A-118N. Each of nodes 116A-116N and/or 118A-118N are accessible via network 106 (e.g., in a “cloud-based” embodiment) to build, deploy, and manage applications and services. Any of nodes 116A-116N and/or 118A-118N may be a storage node that comprises a plurality of physical storage disks that are accessible via network 106 and is configured to store data associated with the applications and services managed by nodes 116A-116N and/or 118A-118N.

Groups of clusters in any combination (e.g., cluster 114A, 114A-B, 114A-E, 114G-N, 114A-N) may represent a data center. In an embodiment, one or more of clusters 114A-114N may be co-located (e.g., housed in one or more nearby buildings with associated components such as backup power supplies, redundant data communications, environmental controls, etc.) to form a data center, or may be arranged in other manners. Accordingly, in an embodiment, one or more of clusters 114A-114N may be a data center in a distributed collection of data centers. In accordance with an embodiment, system 100 comprises part of the Microsoft® Azure® cloud computing platform, owned by Microsoft Corporation of Redmond, Washington, although this is only an example and not intended to be limiting.

Each of node(s) 116A-116N and 118A-118N may comprise one or more server computers, server systems, and/or computing devices. Each of node(s) 116A-116N and 118A-118N may be configured to execute one or more software applications (or “applications”) and/or services and/or manage hardware resources (e.g., processors, memory, etc.), which may be utilized by users (e.g., customers) of the network-accessible server set. Node(s) 116A-116N and 118A-118N may be configured for specific uses, e.g., based on allocations to fulfill customer requests. For example, as shown in FIG. 1A, node 116A may execute virtual machines (VMs) 102A-102N and VMs 122A-122N and node 116N executes VMs 124A-124N and VMs 126A-126N. In some examples, each node in each cluster may be dynamically configured to execute VMs, VM clusters, ML workspaces, scale sets, etc. in response to customer requests.

As shown in FIG. 1A, management service 108 includes a resource manager 110 and a capacity analyzer 112. Management service 108 may be internal and/or external to server infrastructure 104. For instance, management service 108 may be incorporated as a service executing on a computing device of server infrastructure 104. For instance, management service 108 (e.g., or a subservice thereof) may be configured to execute on any of nodes 116A-116N and/or 118A-118N. Alternatively, management service 108 (or a subservice thereof) may be incorporated as a service executing on a computing device external to server infrastructure 104. Furthermore, resource manager 110 and/or capacity analyzer 112 may be incorporated as the same service or subservice. As shown in FIG. 1A, server infrastructure 104 may include a single management service 108; however, it is also contemplated herein that a server infrastructure may include multiple management services. For instance, server infrastructure 104 may include a separate management service for each cluster of clusters 114A-114N (e.g., respective cluster management services).

Computing devices 102A-102N may each be any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. Each of computing devices 102A-102N store data and execute computer programs, applications, and/or services.

Users utilize computing devices 102A-102N to access applications and/or services (e.g., management service 108 and/or subservices thereof, services executing on nodes 116A-116N and/or 118A-118N) offered by the network-accessible server set. For example, a user may be enabled to utilize the applications and/or services offered by the network-accessible server set by signing-up with a cloud services subscription with a service provider of the network-accessible server set (e.g., a cloud service provider). Upon signing up, the user may be given access to a portal of server infrastructure 104, not shown in FIG. 1A. A user may access the portal via computing devices 102A-102N (e.g., by a browser application executing thereon). For example, the user may use a browser executing on computing device 102A to traverse a network address (e.g., a uniform resource locator) to a portal of server infrastructure 104, which invokes a user interface (e.g., a web page) in a browser window rendered on computing device 102A. The user may be authenticated (e.g., by requiring the user to enter user credentials (e.g., a username, password, PIN, etc.)) before being given access to the portal.

Upon being authenticated, the user may utilize the portal to perform various cloud management-related operations (also referred to as “control plane” operations). Such operations include, but are not limited to, creating, deploying, allocating, modifying, and/or deallocating (e.g., cloud-based) compute resources; building, managing, monitoring, and/or launching applications (e.g., ranging from simple web applications to complex cloud-based applications); configuring one or more of node(s) 116A-116N and 118A-118N to operate as a particular server (e.g., a database server, OLAP (Online Analytical Processing) server, etc.); etc. Examples of compute resources include, but are not limited to, virtual machines, virtual machine scale sets, clusters, ML workspaces, serverless functions, storage disks (e.g., maintained by storage node(s) of server infrastructure 104), web applications, database servers, data objects (e.g., data file(s), table(s), structured data, unstructured data, etc.) stored via the database servers, etc. The portal may be configured in any manner, including being configured with any combination of text entry, for example, via a command line interface (CLI), one or more graphical user interface (GUI) controls, etc., to enable user interaction.

Users may use computing devices 102A-102N to request allocation of VMs by management service 108. Management service 108 may allocate computing devices to fulfill requests based on available inventory. Management service 108 (e.g., resource manager 110) may represent or may include a VM allocation service that receives requests from computing devices 102A-102N to create and allocate virtual machines 120A-120N, 122A-122N, 124A-124N, 126A-126N, etc. There may be multiple instances of management service 108. The inventory managed by each instance may or may not overlap. Each instance may maintain a state of computing devices in the inventory of server infrastructure 104. Inventory may be partitioned, for example, based on servers, racks, clusters, and data centers in various regions and zones.

Resource manager 110 may provide current services to entities, e.g., based on the time of request. Resource manager 110 may receive requests from one or more entities (e.g., via computing devices 102A-102N) for virtual machine (VM) allocation. A (e.g., each) request may include one or more parameters indicating, for example, a number of VMs, a prioritized list of VM types (e.g., size, SKU, identifier) indicating a one or more priority VM types (e.g., first or primary type, with or without second, third, fourth priority VM types as substitutes or alternates), location (e.g., region, zone), security (e.g., public key), etc. Specifying one or more alternate types in a request may avoid failures when one or more higher priority types are unavailable to fulfill a request. For example, a user may indicate multiple VM types using a VmSize parameter with a list datatype having multiple values, which may be in an implied or expressly indicated prioritized order: “Standard_E2s_v3”, “Standard_D2s_v4”, “Standard_D2s_v6”, and so on.

Resource manager 110 may provision the request for VM allocation with available VMs of the first priority VM type. Resource manager 110 may determine a capacity shortage of VMs of the first priority VM type to fulfill the request for VM allocation. If the user indicated more than one VM type, resource manager 110 may provision the request for VM allocation with available VMs of the second priority VM type specified in a request. If resource manager 110 determines a capacity shortage of VMs of the first priority VM type and the second priority VM type to fulfill the request for VM allocation, resource manager 110 may provision the request for VM allocation with available VMs of the third priority VM type, and so on, as needed to fulfill a request that indicates additional priorities of VM types (e.g., if the user indicates third, fourth, etc. VM types).

Resource manager 110 may notify an entity providing the request (e.g., user/customer using computing device 102A-102N) about the proposed and/or actual provisioning of the request. Notification may indicate, for example, a quantity of the first priority VM type, a quantity of the second priority VM type, etc. An entity (e.g., via computing device 102A-102N) may respond confirming or rejecting a proposed provisioning.

A request may indicate one or more regions or zones for the multiple priority VMs, such as a first region or a first zone within the first region. Resource manager 110 may determine inadequate priority VMs in the indicated region(s) or zone(s). Resource manager 110 may recommend to an entity providing the request the available VMs (e.g., first priority VM type, second priority VM type) in one or more other regions or zones, such as a second region or a second zone within the second region. Computing device 102A-102N may respond confirming or rejecting provisioning VMs in other regions or zones (e.g., in addition to available priority VMs in regions or zones indicated in the request). In some examples, computing device 102A-102N may reformulate the request or the request may automatically be modified and proposed by resource manager 110, allowing computing device 102A-102N to accept or reject the modified request.

Resource manager 110 may, e.g., based on a capacity shortage to fulfill a request, recommend to an entity (e.g., user/customer) providing the request (e.g., via computing device 102A-102N) available VMs having priorities other than priorities specified in a request, such as a third priority VM type in one or more regions or zones, and/or VMs (of one or more types requested or not requested) in a first region, a first zone in the first region, a second region, and/or a second zone within the second region. Computing device 102A-102N may respond by confirming or rejecting provisioning other priority VMs in other regions or zones (e.g., in addition to available priority VMs in regions or zones indicated in the request). In some examples, a requesting entity may reformulate the request or the request may be modified automatically and proposed by resource manager 110, allowing computing device 102A-102N to accept or reject the modified request.

Resource manager 110 may (e.g., additionally and/or alternatively) provide future-oriented services to entities, such as predicted capacity notifications, recommendations, and/or reservations, for example, based on information provided by capacity analyzer 112. Resource manager 110 may receive indications from entities that indicate whether entities are participating in receiving forward-looking notifications, recommendations, and/or reservations.

Capacity analyzer (e.g., predictor) 112 may analyze capacity by performing multiple predictions. For example, capacity analyzer 112 may generate overall predictions and entity-specific predictions.

For instance, capacity analyzer 112 may access (e.g., in a database storage system) or otherwise determine past (e.g., historical/empirical) VM creation overall for specific entities, e.g., including past compute capacity(ies), timeframe(s), regions, zones (e.g., availability zones), type/class of computing devices, etc. For example, capacity analyzer 112 may access VM creation history 128, which may provide database access to past (e.g., historical/empirical) VM creation overall and for specific entities.

For example, capacity analyzer 112 may perform rolling trend analyses. For example, capacity analyzer 112 may determine the average number of VMs created based on one or more parameters, e.g., per type/SKU, per region, per availability zone, for one or more time-periods of interest to make one or more predictions. Capacity analyzer 112 may use features extracted from near and/or long term historical information to predict used or unused capacity for one or more regions at one or more times in the future (e.g., hours in advance). Capacity analyzer 112 may predict a total number of VMs that may be created. Capacity analyzer 112 may make predictions for a total number of VMs based on historical VM requests. For example, capacity analyzer 112 may predict a future compute capacity for at least one of a region or at least one zone within a region during one or more (e.g., predicted) timeframes.

Capacity analyzer 112 may (e.g., also) perform entity-specific analyses. Capacity analyzer 112 may make VM request predictions for individual customers. For example, capacity analyzer 112 may access or determine past (e.g., historical/empirical) VM creation by an entity. Capacity analyzer 112 may predict a future request for VM creation by the entity (e.g., including predicted compute capacity(ies), timeframe(s), regions, zones, type/class of computing devices, etc.) based on the entity's past VM creation. Capacity analyzer 112 may make predictions, for example, on a rolling basis, e.g., one, two, four, eight, 12, 24 hours in advance.

Capacity analyzer 112 (e.g., and/or resource manager 110) may identify potential capacity shortages for an (e.g., each participating) entity based on an entity's predicted request time and the predicted capacity(ies) of one or more VM types in one or more regions and/or zones the entity is predicted to request (e.g., based on previous requests).

Capacity analyzer 112 may include or may be implemented, e.g., at least in part by, for example, an artificial intelligence (AI) neural network (NN) model. An AI NN model, also referred to herein as a model, may represent an algorithm learned by a machine (e.g., machine learning (ML)). An algorithm/model may be trained on historical/empirical user requests. A trained model may be used for inference/prediction of VM requests. For example, capacity analyzer 112 may use a trained model to predict VM requests by one or more entities (e.g., with empirical information providing historical information to predict future behavior). In other embodiments, capacity analyzer 112 uses a preconfigured process, a state machine, or other algorithm to predict future requests for VM creation by entities.

Capacity analyzer 112 may provide capacity analysis information to resource manager 110. For example, capacity analyzer 112 may provide overall capacity prediction information, entity-specific request prediction information, predictive analyses information, etc. to resource manager 110.

Capacity analyzer 112 or resource manager 110 may take preventative action(s) based on capacity analysis information provided by capacity analyzer 112, for example, by providing capacity notifications, recommendations, and/or reservations for entities (e.g., that indicate participation in receiving notifications, recommendations, and/or reservations). Participating entities may receive courtesy and/or reduced fee temporary/dynamic/situation-specific reservations that can be released manually or automatically, for example, in lieu of paying for static/definitely reserved capacity regardless of use.

Capacity analyzer 112 or resource manager 110 may alert the entity if the predicted future compute capacity is less than, equal to, or greater than the predicted compute capacity. For example, capacity analyzer 112 or resource manager 110 may alert the entity about a future timeframe (e.g., the predicted timeframe or another timeframe, which may be based on the predicted timeframe) when the predicted compute capacity is less than the future compute capacity. The entity may use the information to prepare a request. For example, capacity analyzer 112 or resource manager 110 may alert the entity about a future timeframe (e.g., the predicted timeframe or another timeframe, which may be based on the predicted timeframe) when the predicted compute capacity is equal to or greater than the future compute capacity. The entity may use the information to prepare a request.

In an example, capacity analyzer 112 may determine the historic rate at which the customer has been creating VMs. Capacity analyzer 112 may predict the overall VM creation rate by management service 108, e.g., by region, by type/SKU, and/or by availability zones, which may be referred to as a super set. To validate that an entity can continue VM creations at this rate, capacity analyzer 112 may predict compute capacity for the top VM SKU and regions the customer has been using. This may be referred to as a subset of data. Using both super set and subset data, capacity analyzer 112 and/or resource manager 110 may verify if the expected/predicted requirements for VM creation by participating entities can be met for a selected timeframe. If capacity analyzer 112 or resource manager 110 find any VM SKU-region combination for which there is insufficient capacity, capacity analyzer 112 or resource manager 110 may send the information to management service 108 for a recommendation of the closest VM type/SKU and region combination with a probability of success. The capacity predictions and recommendations, if any, may be provided to respective entities in the form of alerts and/or recommendations, allowing entities to act on the notifications and/or recommendations when making actual requests. Entities may monitor and use capacity predictions, notifications, recommendations, and/or reservations for their VM types and regions to increase their VM creation success rate.

Resource manager 110 may receive an indication (e.g., via computing device 102A-102N) that an entity participates in dynamic reservation of computing capacity for VM allocation. Resource manager 110 may share information with capacity analyzer 112. In some examples, resource manager 110 may receive predictions made by capacity analyzer 112. Resource manager 110 may reserve predicted compute capacity at a predicted timeframe before resource manager 110 receives a request for VM allocation for an entity. Resource manager 110 may provision a (e.g., subsequently received) request for VM allocation with available VMs of the first, second, or other priority VM types from the reserved compute capacity.

Resource manager 110 may release reserved predicted compute capacity (e.g., at or near) the predicted timeframe if an actual request for VM allocation is not received within a time threshold, e.g., based on a start time of the predicted timeframe.

Resource manager 110 may automatically make a reservation of compute capacity for an entity, for example, based on a prediction by capacity analyzer 112 that the future compute capacity may be less than the predicted compute capacity without the reservation.

In an example of preventative action(s), such as dynamic, temporary blocking (reservation), the United States (US) may have 10 regions, with at least 3 availability zones in each region, e.g., for disaster or failure recovery. Customers may (e.g., often) deploy across multiple availability zones to hedge against failures. There may be 100,000 of a particular type of VM (e.g., DS2V2 VMs) in a particular region or zone (e.g., East US 2 region). Capacity analyzer 112 may predict that at 10 PM customer A will create a request for 1,500 VMs of one or more types in East US 2 region. Capacity analyzer 112 may predict that only 1,000 VMs of the type customer A is expected to request will be available, which is a predicted capacity shortage of 500 VMs for customer A. Resource manager 110 may engage in one or more remedies or mitigations (e.g., preventative actions) to overcome the expected shortfall of 500 VMs, for example, by providing capacity notifications, recommendations, and/or reservations. For example, Resource manager 110 may provide a capacity shortfall notification and/or recommendation for a predicted future request (e.g., a recommendation of one or more alternate types, regions, zones, timeframes, etc.). Customer A may use the notification and/or recommendation to provide in the request multiple SKUs (e.g., DS2V2 and E2SV3) in East US 2 region, provide a request in one or more other regions, provide a request at a different time, etc. Resource manager 110 may (e.g., additionally or alternatively) dynamically, temporarily reserve capacity in advance (e.g., at 8 PM), for example, by sending a request to management service 108 (e.g., Azure® Resource Manager™) to block/reserve capacity for customer A at 10 PM. Resource manager 110 may or may not receive a predicted request. Resource manager 110 may indicate to management service to allocate from the reserved capacity to (e.g., at least partially) fulfill a request (e.g., a timely received request relative to a threshold) and/or to release some or all unused capacity, e.g., depending on whether a request was not timely received or depending on the size of a timely received request that may request fewer VMs than were reserved.

In a further example, capacity analyzer 112 may predict that a customer will request 1000 VMs of type DS2V2, that there will be a shortage of 50 VMs of type DS2V2 (e.g., 950 VMs will be available), and that there will be capacity for other VM types for the customer, such as types DS2V6 or ES2V4. This information/alert and recommended use of alternate types DS2V6 or ES2V4 may be provided to the customer.

The customer has several options in response to the alert/recommendation. In a first option, the customer may utilize a VM Create template to indicate multiple VM types/sizes, such as DS2V2 (e.g., as a preferred/priority or default type) and DS2V6 and/or ES2V4 (e.g., as alternate/second/third priority types). Resource manager 110 may, e.g., before or at the time of deploying VMs, check for the default VM type (e.g., DS2V2) and allocate maximum available capacity and for any shortage (e.g., or non-available capacity), allocate the remaining capacity based on the customer preference/priority (e.g., DS2V6 and/or ES2V4).

Another customer option may be to request temporary capacity reservation. In a first scenario, the customer may request reservation of one or more types, e.g., default DS2V2 VM type. The customer may indicate automated or manual reservation for future actual and/or predicted usage. For example, a VM Create template and/or an alert/recommendation message provided by resource manager 110 may provide a customer with an option to indicate a desire to reserve one or more VM types for use in the future (e.g., in a time period, such as the next one hour). Currently (e.g., for a current request) or in a time period when the VM request is actually or expected to be performed, resource manager 110 may allocate available VMs (e.g., 950 VMs of type DS2V2 that were predicted to be available) plus 50 reserved VMs of type DS2V2 to provide 1000 VMs for a request. If, at the time approaching or time of allocation to an actual request, it turns out that 975 VMs are available, then 975 VMs may be allocated along with 25 reserved VMs, while the other 25 reserved VMs may be released from reservation to make them available to other customer requests.

Another option for a predicted or actual request may occur, for example, if there is insufficient capacity for a priority/default VM type (e.g., DS2V2), but there is (e.g., actually or expected/predicted) available capacity for other VM types (e.g., DS2V6 or ES2V4) that the customer can use, an alert/recommendation may be provided to the customer to recommend actual/predicted available VM types with an option for the customer to reserve the one or more types to use in a current or actual/predicted request for a time period (e.g., in the next one hour). Currently (e.g., for a current request) or at the end of the time period when the VM request is actually or expected to be performed, resource manager 110 may allocate available VMs (e.g., 950 VMs of type DS2V2 that were predicted to be available) plus 50 reserved VMs of type DS2V6 or ES2V4 to provide 1000 VMs for a request. If, at the time approaching or time of allocation to an actual request, it turns out that 975 VMs are available, then 975 VMs (e.g., of default type DS2V2) may be allocated along with 25 reserved VMs (e.g., of type DS2V6 or ES2V4), while the other 25 reserved VMs may be released from reservation to make them available to other customer requests.

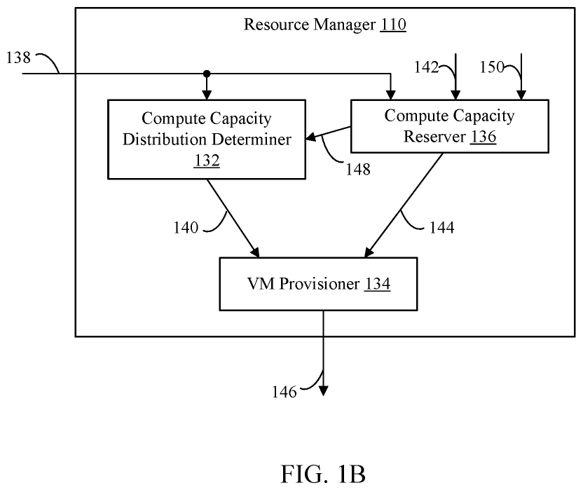

For illustrative purposes, example structure and operation of resource manager 110 shown in FIG. 1A is described below with respect to FIGS. 1B and 2. FIG. 1B shows a block diagram of resource manager 110, in accordance with an example embodiment. As shown in FIG. 1B, resource manager 110 of FIG. 1A may include a compute capacity distribution determiner 132, a virtual machine (VM) provisioner 134, and a compute capacity reserver 136. Note that not all of these components of resource manager 110 of FIG. 1B need be present in all embodiments, as further illustrated below. Furthermore, FIG. 2 shows a flowchart 200 of a process for avoiding VM deployment failures by making and fulfilling VM requests from multiple types of VMs, in accordance with an embodiment. Resource manager 110 of FIGS. 1A and 1B may operate according to flowchart 200 in embodiments. Note that not all steps of flowchart 200 need be performed in all embodiments. Further structural and operational embodiments will be apparent to persons skilled in the relevant art(s) based on the following description of FIGS. 1A, 1B, and 2.

Flowchart 200 begins with step 202. In step 202, a resource manager may receive a request by an entity for virtual machine (VM) allocation. The request may comprise a number of VMs, a first priority VM type, and a second priority VM type. For example, as shown in FIG. 1A, a user may use computing device 102A to send a VM creation request to management service 108, which may be handled by resource manager 110. As shown in FIG. 1B, a VM creation request 138 is received by resource manager 110, including being received by compute capacity distribution determiner 132 of resource manager 110. Request 138 may indicate a quantity of VMs, a first priority VM type, and a second priority VM type.

In step 204, the request for VM allocation may be provisioned with available VMs of the first priority VM type. For example, as shown in FIG. 1A, resource manager 110 may provision the request with an available quantity of first priority type VMs, if any. For instance, as shown in FIG. 1B, compute capacity distribution determiner 132 may determine a number of VMs of the first priority VM type that are available (e.g., not already allocated to other users), and provide this number to VM provisioner 146 as a VM allocation quantity 140. VM provisioner 146 may provision this determined quantity to the user of computing device 102A who submitted request 138. This provisioned quantity of VM allocation quantity 140 may be a number less than the number requested in request 138.

In step 206, a determination is made that there is a capacity shortage of VMs of the first priority VM type to fulfill the request for VM allocation. For example, as shown in FIG. 1A, resource manager 110 may determine that the available quantity of the first type of VMs is less than the quantity of requested VMs. In particular, with respect to FIG. 1B, compute capacity distribution determiner 132 may determine that the number of VMS of the first priority VM type that are available is less than the requested number of such VMs received in request 138.

In step 208, the request for VM allocation may be provisioned with available VMs of the second priority VM type. For example, as shown in FIG. 1A, resource manager 110 may provision the request with an available quantity of second priority type VMs, which may be up to the quantity of requested VMs. In particular, with respect to FIG. 1B, compute capacity distribution determiner 132 may determine a number of VMs of the second priority VM type that are available and provide this number to VM provisioner 146 as VM allocation quantity 140. VM provisioner 146 may provision this determined quantity to the user of computing device 102A who submitted request 138.

Note that after step 208, operation of flowchart 200 may return to step 206, where the total quantity of VMs of the first and second priority VM types provisioned by compute capacity distribution determiner 132 (in VM allocation quantity 140) may be determined by compute capacity distribution determiner 132 to be a sum less than the number of VMs requested in the VM allocation request of request 138. In such case, step 208 of flowchart 200 may be performed again by compute capacity distribution determiner 132 and VM provisioner 146. In particular, compute capacity distribution determiner 132 may determine a number of VMs of a subsequent priority VM type (e.g., third, fourth, etc.) that are available and provide this number to VM provisioner 146 as VM allocation quantity 140. VM provisioner 146 may provision this determined quantity to the user of computing device 102A who submitted request 138. Steps 206 and 208 may be repeated in this manner any number of times for further priority VM types until the user receives the requested number of VMS.

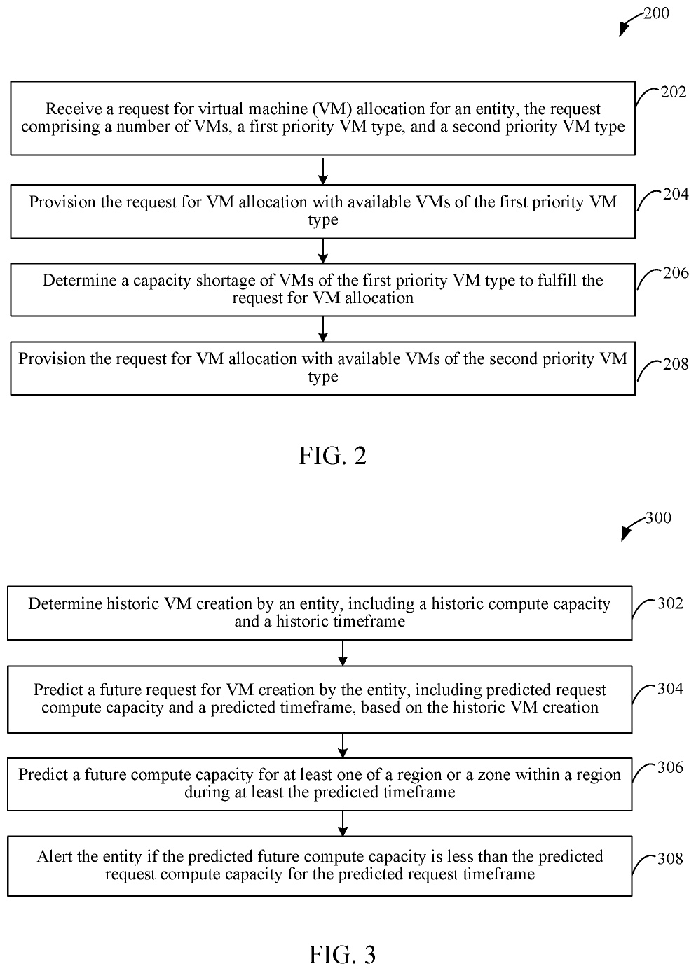

For illustrative purposes, example operation of capacity analyzer 112 shown in FIG. 1A is described below with respect to FIG. 3. FIG. 3 shows a flowchart 300 of a process for avoiding VM deployment failures through VM capacity prediction, VM request prediction, and mitigation by notification, in accordance with an embodiment. Capacity analyzer 112 may operate according to flowchart 300 in embodiments. Note that not all steps of flowchart 300 need be performed in all embodiments. Further structural and operational embodiments will be apparent to persons skilled in the relevant art(s) based on the following description of FIG. 3.

Flowchart 300 begins with step 302. In step 302, a capacity analyzer may determine (e.g., access or retrieve) historic VM creation by an entity, including a historic compute capacity and a historic timeframe. For example, as shown in FIG. 1A, capacity analyzer 312 may access historic VM creation information from VM creation history 128, which may include overall and entity-by-entity VM creation.

In step 304, a future request for VM creation by the entity may be predicted based on the historic VM creation. The prediction may include predicted compute capacity and a predicted timeframe. For example, as shown in FIG. 1A, capacity analyzer 112 may predict that one or more entities may make requests for VM creation of particular VM quantities, VM types, regions, zones, and/or times (e.g., over the next several hours) based on their history of VM requests.

In step 306, a future compute capacity may be predicted for at least one of a region or a zone within a region during at least the predicted timeframe. For example, as shown in FIG. 1A, capacity analyzer 112 may analyze overall VM request history in a trend analysis to predict VM capacity, e.g., for VM types, regions, zones, and/or times predicted relative to the one or more predicted requests.

In step 308, the entity may be alerted if the predicted future compute capacity is less than the predicted request compute capacity. For example, as shown in FIG. 1A, capacity analyzer 112 or resource manager 110 may notify an entity if the predicted future capacity in a region and/or zone at a predicted request timeframe is less that the predicted request compute capacity in a predicted future request for VM creation from the entity.

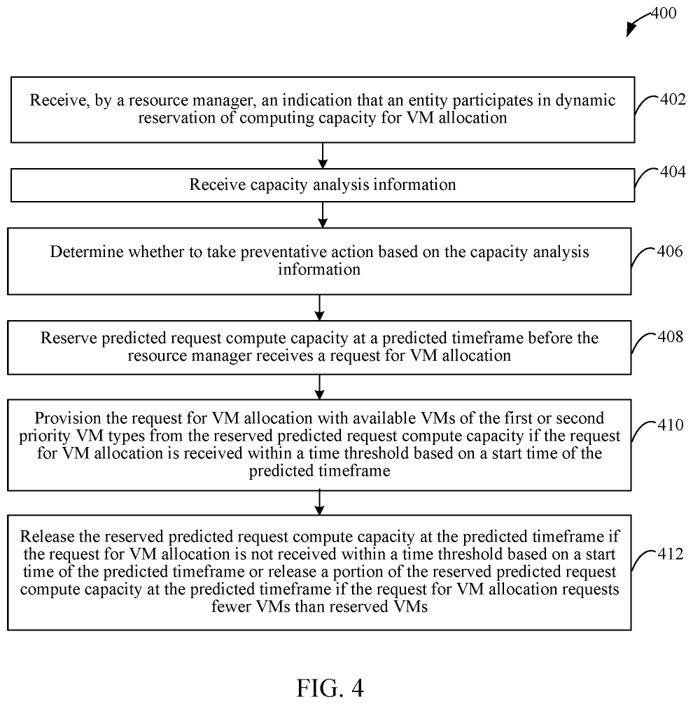

For illustrative purposes, further example structure and operation of resource manager 110 and capacity analyzer 112 shown in FIGS. 1A and 1B are described below with respect to FIG. 4. FIG. 4 shows a flowchart 400 of a process for avoiding VM deployment failures through VM capacity prediction, VM request prediction, and mitigation by VM reservation, in accordance with an embodiment. Resource manager 110 and capacity analyzer 112 may operate according to flowchart 400 in embodiments. Note that not all steps of flowchart 400 need be performed in all embodiments. Further structural and operational embodiments will be apparent to persons skilled in the relevant art(s) based on the following description of FIG. 4.

Flowchart 400 begins with step 402. In step 402, a resource manager may receive an indication that an entity participates in dynamic reservation regarding computing capacity for VM allocation. For example, as shown in FIG. 1A, an entity may use computing device 102A to indicate to management service 108, which may be handled by resource manager 110, that the entity participates in notifications, recommendations, and/or dynamic reservation regarding computing capacity for VM allocation. With reference to FIG. 1B, compute capacity reserver 136 may receive a dynamic reservation opt-in indication 142 that indicates the entity opts into dynamic reservation of VM allocation, such that anticipated VM needs of the entity may be automatically predicted and reserved. Dynamic reservation opt-in indication 142 may be received from a computing device of the entity (e.g., computing device 102A of FIG. 1), from a profile stored in storage for the entity, or elsewhere.

In step 404, capacity analysis information may be received. For example, as shown in FIG. 1A, resource manager 110 may receive capacity analysis information from capacity analyzer 112. In FIG. 1B, compute capacity reserver 136 may receive capacity analysis information 150 from capacity analyzer 112, which includes the above-described capacity analysis information, such as historical information/trends regarding VM allocation requests by the entity (e.g., past times of requests, past quantities of requests, past requested VM types, etc.).

In step 406, a determination may be made whether to take preventative action, e.g., by providing capacity notifications, recommendations, and/or reservations, based on the capacity analysis information. For example, as shown in FIG. 1A, resource manager 110 may determine whether to take one or more preventative actions for an entity based on the capacity analysis information and based on whether the entity participates in capacity notifications, recommendations, and/or reservations. In particular, due to the entity having opted into automatic VM capacity reservation (via signal 142), compute capacity reserver 136 may be configured to predict a likely future VM capacity based on capacity analysis information 150. The predicted future VM compute capacity may include a time of a predicted VM compute capacity and/or need by the entity, a predicted quantity of requested VMs by the entity, one or more predicted types of VMs requested by the entity, and/or any other predicted information regarding a potential VM allocation request by the entity.

In step 408, the predicted request compute capacity may be reserved at the predicted timeframe before the resource manager receives a request for VM allocation. For example, as shown in FIG. 1A, resource manager 110 may reserve compute capacity for an entity consistent with a predicted future request for VM creation in the capacity analysis information if the entity participates in dynamic capacity reservations, e.g., and if the capacity analysis information indicates there may be insufficient capacity for the predicted future request without the dynamic reservation. For instance, as shown in FIG. 1B, compute capacity reserver 136 may transmit a predicted VM compute capacity 148 to compute capacity distribution determiner 132 so that compute capacity distribution determiner 132 will withhold/reserve the predicted VM compute capacity for entity from VM allocations to other entities. Compute capacity distribution determiner 132 may hold the reservation for a predetermined amount of time from receipt of VM compute capacity 148, for an amount of time indicated in VM compute capacity 148, until a predetermined amount of time passes a predicted request time by the entity for the predicted VM allocation, or for another time period.

In step 410, the request for VM allocation may be provisioned with available VMs of the first or second priority VM types from the reserved compute capacity if the request for VM allocation is received within a time threshold based on a start time of the predicted timeframe. For example, as shown in FIG. 1A, resource manager 410 may request that management service 108 provision a timely request received using compute capacity (e.g., of reserved predicted first and/or second types) reserved for the predicted future request for VM creation. In further detail, as described above, VM creation request 138 may be received by compute capacity distribution determiner 132 from the entity. Compute capacity distribution determiner 132 may be configured to allocate VMs to the entity based on VM creation request 138. Furthermore, compute capacity distribution determiner 132 may allocate the requested VMs from the reserved VM capacity set by predicted VM compute capacity 148.

In step 412, unused dynamically reserved compute capacity may be released depending on the circumstances. For example, all of the reserved predicted compute capacity may be released at the predicted timeframe if the request for VM allocation is not received within a time threshold based on a start time of the predicted timeframe. For example, a portion of the reserved predicted compute capacity may be released at the predicted timeframe if the request for VM allocation requests fewer VMs than reserved VMs. For example, as shown in FIG. 1A, resource manager 110 (e.g., compute capacity distribution determiner 132 of FIG. 1B) may request that management service 108 release all compute capacity reserved for a predicted future request if an actual request is not timely received. Resource manager 110 (e.g., compute capacity distribution determiner 132 of FIG. 1B) may request that management service 108 release any unused portion of compute capacity reserved for a predicted future request if an actual request is timely received, but uses less than the reserved compute capacity.

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

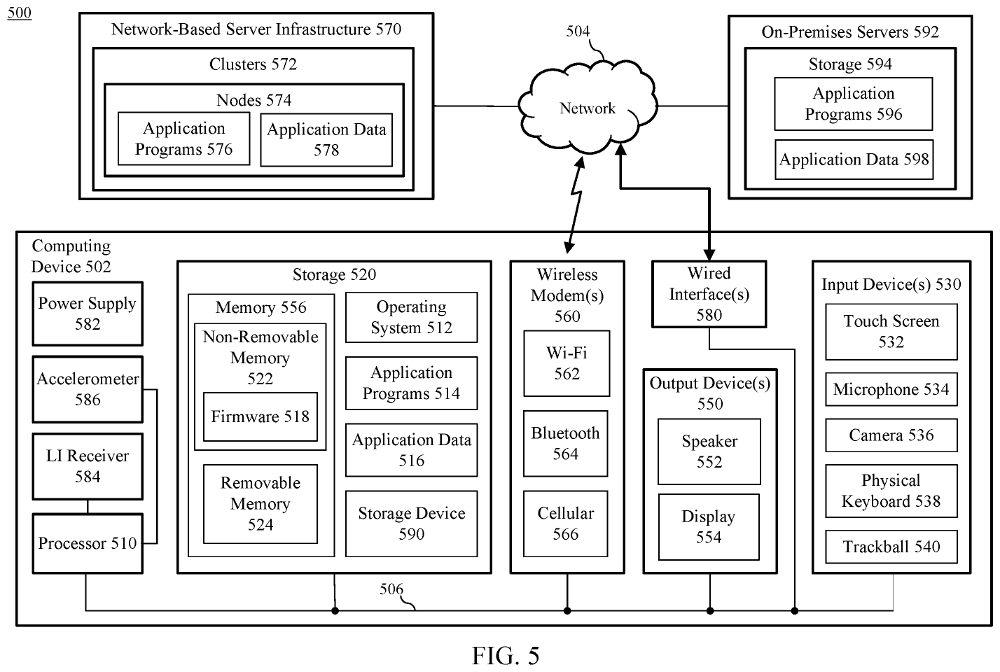

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 5. FIG. 5 shows a block diagram of an exemplary computing environment 500 that includes a computing device 502. Computing device 502 is an example of computing device 102A-102N, node 116A-N, node 118A-N, and/or another computing device of server infrastructure 104 as described with respect to FIG. 1A, each of which may include one or more of the components of computing device 502. In some embodiments, computing device 502 is communicatively coupled with devices (not shown in FIG. 5) external to computing environment 500 via network 1004. Network 504 is an example of network 106 of FIG. 1A. Network 504 comprises one or more networks such as local area networks (LANs), wide area networks (WANs), enterprise networks, the Internet, etc., and may include one or more wired and/or wireless portions. Network 504 may additionally or alternatively include a cellular network for cellular communications. Computing device 1002 is described in detail as follows.

Computing device 502 can be any of a variety of types of computing devices. For example, computing device 502 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 502 may alternatively be a stationary computing device such as a desktop computer, a personal computer (PC), a stationary server device, a minicomputer, a mainframe, a supercomputer, etc.

As shown in FIG. 5, computing device 502 includes a variety of hardware and software components, including a processor 510, a storage 520, one or more input devices 530, one or more output devices 550, one or more wireless modems 560, one or more wired interfaces 580, a power supply 582, a location information (LI) receiver 584, and an accelerometer 586. Storage 520 includes memory 556, which includes non-removable memory 522 and removable memory 524, and a storage device 590. Storage 520 also stores an operating system 512, application programs 514, and application data 516. Wireless modem(s) 560 include a Wi-Fi modem 562, a Bluetooth modem 564, and a cellular modem 566. Output device(s) 550 includes a speaker 552 and a display 554. Input device(s) 530 includes a touch screen 532, a microphone 534, a camera 536, a physical keyboard 538, and a trackball 540. Not all components of computing device 502 shown in FIG. 5 are present in all embodiments, additional components not shown may be present, and any combination of the components may be present in a particular embodiment. These components of computing device 502 are described as follows.

A single processor 510 (e.g., central processing unit (CPU), microcontroller, a microprocessor, signal processor, ASIC (application specific integrated circuit), and/or other physical hardware processor circuit) or multiple processors 510 may be present in computing device 502 for performing such tasks as program execution, signal coding, data processing, input/output processing, power control, and/or other functions. Processor 510 may be a single-core or multi-core processor, and each processor core may be single-threaded or multithreaded (to provide multiple threads of execution concurrently). Processor 510 is configured to execute program code stored in a computer readable medium, such as program code of operating system 512 and application programs 514 stored in storage 520. Operating system 512 controls the allocation and usage of the components of computing device 502 and provides support for one or more application programs 514 (also referred to as “applications” or “apps”). Application programs 514 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 502 can communicate with any other component according to function, although not all connections are shown for case of illustration. For instance, as shown in FIG. 5, bus 506 is a multiple signal line communication medium (e.g., conductive traces in silicon, metal traces along a motherboard, wires, etc.) that may be present to communicatively couple processor 510 to various other components of computing device 502, although in other embodiments, an alternative bus, further buses, and/or one or more individual signal lines may be present to communicatively couple components. Bus 506 represents one or more of any of several types of bus structures, including a memory bus or memory controller, a peripheral bus, an accelerated graphics port, and a processor or local bus using any of a variety of bus architectures.

Storage 520 is physical storage that includes one or both of memory 556 and storage device 590, which store operating system 512, application programs 514, and application data 516 according to any distribution. Non-removable memory 522 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 522 may include main memory and may be separate from or fabricated in a same integrated circuit as processor 510. As shown in FIG. 5, non-removable memory 522 stores firmware 518, which may be present to provide low-level control of hardware. Examples of firmware 518 include BIOS (Basic Input/Output System, such as on personal computers) and boot firmware (e.g., on smart phones). Removable memory 524 may be inserted into a receptacle of or otherwise coupled to computing device 502 and can be removed by a user from computing device 502. Removable memory 524 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 590 may be present that are internal and/or external to a housing of computing device 502 and may or may not be removable. Examples of storage device 590 include a hard disk drive, a SSD, a thumb drive (e.g., a USB (Universal Serial Bus) flash drive), or other physical storage device.

One or more programs may be stored in storage 520. Such programs include operating system 512, one or more application programs 514, and other program modules and program data. Examples of such application programs may include, for example, computer program logic (e.g., computer program code/instructions) for implementing one or more of management service 108, resource manager 110, capacity analyzer 112, cluster 114A-N, node 116A-N, node 118A-N, VM 120A-N, VM 122A-N, VM 124A-N, VM 126A-N, compute capacity distribution determiner 132, VM provisioner 134, compute capacity reserver 136, along with any components and/or subcomponents thereof, as well as the flowcharts/flow diagrams (e.g., flowcharts 200, 300, and/or 400) described herein, including portions thereof, and/or further examples described herein.

Storage 520 also stores data used and/or generated by operating system 512 and application programs 514 as application data 516. Examples of application data 516 include web pages, text, images, tables, sound files, video data, and other data, which may also be sent to and/or received from one or more network servers or other devices via one or more wired or wireless networks. Storage 520 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 502 through one or more input devices 530 and may receive information from computing device 502 through one or more output devices 550. Input device(s) 530 may include one or more of touch screen 532, microphone 534, camera 536, physical keyboard 538 and/or trackball 540 and output device(s) 550 may include one or more of speaker 552 and display 554. Each of input device(s) 530 and output device(s) 550 may be integral to computing device 502 (e.g., built into a housing of computing device 502) or external to computing device 502 (e.g., communicatively coupled wired or wirelessly to computing device 502 via wired interface(s) 580 and/or wireless modem(s) 560). Further input devices 530 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 554 may display information, as well as operating as touch screen 532 by receiving user commands and/or other information (e.g., by touch, finger gestures, virtual keyboard, etc.) as a user interface. Any number of each type of input device(s) 530 and output device(s) 550 may be present, including multiple microphones 534, multiple cameras 536, multiple speakers 552, and/or multiple displays 554.

One or more wireless modems 560 can be coupled to antenna(s) (not shown) of computing device 502 and can support two-way communications between processor 510 and devices external to computing device 502 through network 504, as would be understood to persons skilled in the relevant art(s). Wireless modem 560 is shown generically and can include a cellular modem 566 for communicating with one or more cellular networks, such as a GSM network for data and voice communications within a single cellular network, between cellular networks, or between the mobile device and a public switched telephone network (PSTN). Wireless modem 560 may also or alternatively include other radio-based modem types, such as a Bluetooth modem 564 (also referred to as a “Bluetooth device”) and/or Wi-Fi 562 modem (also referred to as an “wireless adaptor”). Wi-Fi modem 562 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 564 is configured to communicate with another Bluetooth-capable device according to the Bluetooth short-range wireless technology standard(s) such as IEEE 802.15.1 and/or managed by the Bluetooth Special Interest Group (SIG).

Computing device 502 can further include power supply 582, LI receiver 584, accelerometer 586, and/or one or more wired interfaces 580. Example wired interfaces 580 include a USB port, IEEE 594 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 580 of computing device 502 provide for wired connections between computing device 502 and network 504, or between computing device 502 and one or more devices/peripherals when such devices/peripherals are external to computing device 502 (e.g., a pointing device, display 554, speaker 552, camera 536, physical keyboard 538, etc.). Power supply 582 is configured to supply power to each of the components of computing device 502 and may receive power from a battery internal to computing device 502, and/or from a power cord plugged into a power port of computing device 502 (e.g., a USB port, an A/C power port). LI receiver 584 may be used for location determination of computing device 502 and may include a satellite navigation receiver such as a Global Positioning System (GPS) receiver or may include other type of location determiner configured to determine location of computing device 502 based on received information (e.g., using cell tower triangulation, etc.). Accelerometer 586 may be present to determine an orientation of computing device 502.

Note that the illustrated components of computing device 502 are not required or all-inclusive, and fewer or greater numbers of components may be present as would be recognized by one skilled in the art. For example, computing device 502 may also include one or more of a gyroscope, barometer, proximity sensor, ambient light sensor, digital compass, etc. Processor 510 and memory 556 may be co-located in a same semiconductor device package, such as being included together in an integrated circuit chip, FPGA, or system-on-chip (SOC), optionally along with further components of computing device 502.

In embodiments, computing device 502 is configured to implement any of the above-described features of flowcharts herein. Computer program logic for performing any of the operations, steps, and/or functions described herein may be stored in storage 520 and executed by processor 510.

In some embodiments, server infrastructure 570 may be present in computing environment 500 and may be communicatively coupled with computing device 502 via network 504. Server infrastructure 570, when present, may be a network-accessible server set (e.g., a cloud-based environment or platform). As shown in FIG. 5, server infrastructure 570 includes clusters 572. Each of clusters 572 may comprise a group of one or more compute nodes and/or a group of one or more storage nodes. For example, as shown in FIG. 5, cluster 572 includes nodes 574. Each of nodes 574 are accessible via network 504 (e.g., in a “cloud-based” embodiment) to build, deploy, and manage applications and services. Any of nodes 574 may be a storage node that comprises a plurality of physical storage disks, SSDs, and/or other physical storage devices that are accessible via network 504 and are configured to store data associated with the applications and services managed by nodes 574. For example, as shown in FIG. 5, nodes 574 may store application data 578.

Each of nodes 574 may, as a compute node, comprise one or more server computers, server systems, and/or computing devices. For instance, a node 574 may include one or more of the components of computing device 502 disclosed herein. Each of nodes 574 may be configured to execute one or more software applications (or “applications”) and/or services and/or manage hardware resources (e.g., processors, memory, etc.), which may be utilized by users (e.g., customers) of the network-accessible server set. For example, as shown in FIG. 5, nodes 574 may operate application programs 576. In an implementation, a node of nodes 574 may operate or comprise one or more virtual machines, with each virtual machine emulating a system architecture (e.g., an operating system), in an isolated manner, upon which applications such as application programs 576 may be executed.

In an embodiment, one or more of clusters 572 may be co-located (e.g., housed in one or more nearby buildings with associated components such as backup power supplies, redundant data communications, environmental controls, etc.) to form a data center, or may be arranged in other manners. Accordingly, in an embodiment, one or more of clusters 572 may be a data center in a distributed collection of data centers. In embodiments, exemplary computing environment 500 comprises part of a cloud-based platform such as Amazon Web Services® of Amazon Web Services, Inc., or Google Cloud Platform™ of Google LLC, although these are only examples and are not intended to be limiting.

In an embodiment, computing device 502 may access application programs 576 for execution in any manner, such as by a client application and/or a browser at computing device 502. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 502 may additionally and/or alternatively synchronize copies of application programs 514 and/or application data 516 to be stored at network-based server infrastructure 570 as application programs 576 and/or application data 578. For instance, operating system 512 and/or application programs 514 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 520 at network-based server infrastructure 570.

In some embodiments, on-premises servers 592 may be present in computing environment 500 and may be communicatively coupled with computing device 502 via network 504. On-premises servers 592, when present, are hosted within an organization's infrastructure and, in many cases, physically onsite of a facility of that organization. On-premises servers 592 are controlled, administered, and maintained by IT (Information Technology) personnel of the organization or an IT partner to the organization. Application data 598 may be shared by on-premises servers 592 between computing devices of the organization, including computing device 502 (when part of an organization) through a local network of the organization, and/or through further networks accessible to the organization (including the Internet). Furthermore, on-premises servers 592 may serve applications such as application programs 596 to the computing devices of the organization, including computing device 502. Accordingly, on-premises servers 592 may include storage 594 (which includes one or more physical storage devices such as storage disks and/or SSDs) for storage of application programs 596 and application data 598 and may include one or more processors for execution of application programs 596. Still further, computing device 502 may be configured to synchronize copies of application programs 514 and/or application data 516 for backup storage at on-premises servers 592 as application programs 596 and/or application data 598.

Embodiments described herein may be implemented in one or more of computing device 502, network-based server infrastructure 570, and on-premises servers 592. For example, in some embodiments, computing device 502 may be used to implement systems, clients, or devices, or components/subcomponents thereof, disclosed elsewhere herein. In other embodiments, a combination of computing device 502, network-based server infrastructure 570, and/or on-premises servers 592 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 520. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 514) may be stored in storage 520. Such computer programs may also be received via wired interface(s) 580 and/or wireless modem(s) 560 over network 504. Such computer programs, when executed or loaded by an application, enable computing device 502 to implement features of embodiments discussed herein. Accordingly, such computer programs represent controllers of the computing device 502.

Embodiments are also directed to computer program products comprising computer code or instructions stored on any computer-readable medium or computer-readable storage medium. Such computer program products include the physical storage of storage 520 as well as further physical storage types.

### VI. Additional Example Embodiments

Systems, methods, and instrumentalities are described herein related to capacity prediction & management for virtual machine (VM) deployment. A resource manager receives requests by entities for VM allocation. Requests may include compute capacity parameter(s) indicating, for example, a number of VMs, one or more regions or zones within one or more regions, and a prioritized list of VM types indicating a first priority VM type, and other priority VM types (e.g., second, third, etc. priority VM types) as substitute or alternate VMs. The resource manager provisions the request for VM allocation with available VMs of the first priority VM type. If the resource manager determines a capacity shortage of VMs of the first priority VM type to fulfill the request for VM allocation, the resource manager may provision the request for VM allocation with available VMs of the second, third, etc. priority VM type(s).

The resource manager may notify an entity providing a request about the provisioning of the request, e.g., including a quantit(ies) of the first, second, third, etc. priority VM types available for provisioning for a workload. The resource manager may recommend (e.g., to an entity providing the request) about available VMs of the first, second, third, etc. priority VM types in other regions and/or zones (e.g., a second region or a second zone within the second region). The resource manager may recommend (e.g., to an entity providing the request) available VMs of other priorities not requested (e.g., a third priority VM type) in one or more requested or unrequested regions or zones. The requestor may accept or reject provisioning and/or recommendations.

The resource manager may interact with a capacity analyzer. A capacity analyzer (e.g., a machine learning predictor) may determine (e.g., learn) past (e.g., historical) VM creation by an entity, such as past compute capacity(ies) (e.g., VM quantity, VM type), timeframe(s), region(s), zone(s), etc. The capacity analyzer may predict a future request for VM creation by the entity, including a predicted compute capacity, a predicted timeframe, predicted region(s), predicted zone(s), etc., based on the entity's past VM creation. The capacity analyzer may predict a future compute capacity for one or more regions and/or zones within regions during the predicted timeframe and/or other timeframes. The capacity analyzer may alert the entity if the predicted future compute capacity is less than the predicted compute capacity. The capacity analyzer may alert the entity about a future timeframe when the predicted compute capacity is equal to or greater than the future compute capacity.

The resource manager may receive an indication that the entity participates in dynamic reservation of computing capacity for VM allocation. The resource manager may reserve the predicted compute capacity at the predicted timeframe before the resource manager receives the request for VM allocation. A reservation may be automatic based on a prediction by the capacity analyzer that the future compute capacity will be less than the predicted compute capacity without the reservation. The resource manager may provision a request for VM allocation (e.g., during the reserved timeframe) with available VMs (e.g., of the requested first or second priority VM types) from the reserved compute capacity. The resource manager may release the reserved predicted compute capacity at the predicted timeframe if the request for VM allocation is not received within a time threshold based on a start time of the predicted timeframe.

A system is described herein. The system comprises a processor circuit and a memory. The memory stores program code that is executable by the processor circuit to perform the foregoing method.

In examples, a computing device may comprise one or more processors and one or more memory devices that store program code configured to be executed by the one or more processors. The program code may comprise a resource manager configured to receive a request by an entity for virtual machine (VM) allocation, the request comprising (e.g., parameter(s) indicating) a number of VMs (e.g., and a prioritized list of VM types indicating), a first priority VM type, and a second priority VM type (e.g., substitute, alternate). The resource manager may provision the request for VM allocation with available VMs of the first priority VM type. The resource manager may determine a capacity shortage of VMs of the first priority VM type to fulfill the request for VM allocation. The resource manager may provision the request for VM allocation with available VMs of the second priority VM type.

In examples, the request may (e.g., further) comprise a third priority VM type. The resource manager may be (e.g., further) configured to determine a capacity shortage of VMs of the first priority VM type and the second priority VM type to fulfill the request for VM allocation. The resource manager may provision the request for VM allocation with available VMs of the third priority VM type.

In examples, the resource manager may be (e.g., further) configured to notify an entity providing the request about the provisioning of the request including a quantity of the first priority VM type and a quantity of the second priority VM type.

In examples, the request may (e.g., further) comprise an indication of the first and second priority VMs in a first region or a first zone within the first region. The resource manager may be (e.g., further) configured to recommend to an entity providing the request available VMs of at least one of the first priority VM type or the second priority VM type in a second region or a second zone within the second region.

In examples, the request may (e.g., further) comprise an indication of the first and second priority VMs in a first region or a first zone within the first region. The resource manager may be (e.g., further) configured to recommend to an entity providing the request available VMs of a third priority VM type in at least one of the first region, the first zone, a second region, or a second zone within the second region.

In examples, the program code may (e.g., further) comprise a capacity analyzer (e.g., predictor), which may be configured to determine a past VM creation by an entity, including past compute capacity and a past timeframe. The capacity analyzer may be configured to predict a future request for VM creation by the entity, including predicted compute capacity and a predicted timeframe, based on the past VM creation. The capacity analyzer may be configured to predict a future compute capacity for at least one of a region or a zone within a region during at least the predicted timeframe. The capacity analyzer may be configured to alert the entity if the predicted future compute capacity is less than the predicted compute capacity.

In examples, the capacity analyzer may be (e.g., further) configured to alert the entity about a future timeframe when the predicted compute capacity is equal to or greater than the future compute capacity.

In examples, the resource manager may be (e.g., further) configured to receive an indication that the entity participates in dynamic reservation of computing capacity for VM allocation; reserve the predicted compute capacity at the predicted timeframe before the resource manager receives the request for VM allocation; and provision the request for VM allocation with available VMs of the first or second priority VM types from the reserved compute capacity.

In examples, the resource manager may be (e.g., further) configured to release the reserved predicted compute capacity at the predicted timeframe if the request for VM allocation is not received within a time threshold based on a start time of the predicted timeframe.

In examples, the reservation may be automatic based on a prediction by the capacity analyzer that the future compute capacity will be less than the predicted compute capacity without the reservation.

A method may be implemented in a computing device. The method may comprise, for example, receiving (e.g., by resource manager) a request by an entity for virtual machine (VM) allocation, the request comprising (e.g., parameter(s) indicating) a number (e.g., quantity) of VMs (e.g., and a prioritized list of VM types indicating), a first priority VM type, and a second priority VM type (e.g., substitute, alternate); provisioning the request for VM allocation with available VMs of the first priority VM type; determining a capacity shortage of VMs of the first priority VM type to fulfill the request for VM allocation; and provisioning the request for VM allocation with available VMs of the second priority VM type based on the capacity shortage.

In examples, the request may (e.g., further) comprise an indication of the first and second priority VMs in a first region or a first zone within the first region. The method may (e.g., further) comprise recommending to an entity providing the request available VMs of at least one of the first priority VM type or the second priority VM type in a second region or a second zone within the second region.

In examples, the request may (e.g., further) comprise an indication of the first and second priority VMs in a first region or a first zone within the first region. The method may (e.g., further) comprise recommending to an entity providing the request available VMs of a third priority VM type in at least one of the first region, the first zone, a second region, or a second zone within the second region.

In examples, the method may (e.g., further) comprise determining (e.g., by a capacity analyzer/predictor) a past VM creation by an entity, including past compute capacity and a past timeframe; predicting a future request for VM creation by the entity, including predicted compute capacity and a predicted timeframe, based on the past VM creation; predicting a future compute capacity for at least one of a region or a zone within a region during at least the predicted timeframe; and alerting the entity if the predicted future compute capacity is less than the predicted compute capacity.

In examples, the method may (e.g., further) comprise receiving an indication that the entity participates in dynamic reservation of computing capacity for VM allocation; reserving the predicted compute capacity at the predicted timeframe before the resource manager receives the request for VM allocation; and provisioning the request for VM allocation with available VMs of the first or second priority VM types from the reserved compute capacity.

In examples, the method may (e.g., further) comprise releasing the reserved predicted compute capacity at the predicted timeframe if the request for VM allocation is not received within a time threshold based on a start time of the predicted timeframe.

A computer-readable storage medium is described herein. The computer-readable storage medium has computer program logic recorded thereon that when executed by a processor circuit causes the processor circuit to perform a method. The method may comprise, for example, receiving (e.g., by resource manager) a request by an entity for virtual machine (VM) allocation, the request comprising (e.g., parameter(s) indicating) a number (e.g., quantity) of VMs (e.g., and a prioritized list of VM types indicating), a first priority VM type, and a second priority VM type (e.g., substitute, alternate); provisioning the request for VM allocation with available VMs of the first priority VM type; determining a capacity shortage of VMs of the first priority VM type to fulfill the request for VM allocation; and provisioning the request for VM allocation with available VMs of the second priority VM type based on the capacity shortage.

In examples, the request may (e.g., further) comprise an indication of the first and second priority VMs in a first region or a first zone within the first region. The method may (e.g., further) comprise recommending to an entity providing the request available VMs of at least one of the first priority VM type or the second priority VM type in a second region or a second zone within the second region; and/or recommending to an entity providing the request available VMs of a third priority VM type in at least one of the first region, the first zone, a second region, or a second zone within the second region.

In examples, the method may (e.g., further) comprise determining (e.g., by a capacity analyzer/predictor) a past VM creation by an entity, including past compute capacity and a past timeframe; predicting a future request for VM creation by the entity, including predicted compute capacity and a predicted timeframe, based on the past VM creation; predicting a future compute capacity for at least one of a region or a zone within a region during at least the predicted timeframe; and alerting the entity if the predicted future compute capacity is less than the predicted compute capacity.

In examples, the method may (e.g., further) comprise receiving an indication that the entity participates in dynamic reservation of computing capacity for VM allocation; reserving the predicted compute capacity at the predicted timeframe before the resource manager receives the request for VM allocation; and provisioning the request for VM allocation with available VMs of the first or second priority VM types from the reserved compute capacity.

### VII. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

For example, running examples have been described with respect to malicious activity detectors determining whether compute resource creation operations potentially correspond to malicious activity. However, it is also contemplated herein that malicious activity detectors may be used to determine whether other types of control plane operations potentially correspond to malicious activity.

Several types of impactful operations have been described herein; however, lists of impactful operations may include other operations, such as, but not limited to, accessing enablement operations, creating and/or activating new (or previously-used) user accounts, creating and/or activating new subscriptions, changing attributes of a user or user group, changing multi-factor authentication settings, modifying federation settings, changing data protection (e.g., encryption) settings, elevating another user account's privileges (e.g., via an admin account), retriggering guest invitation e-mails, and/or other operations that impact the cloud-base system, an application associated with the cloud-based system, and/or a user (e.g., a user account) associated with the cloud-based system.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system, comprising:
a processor; and
a memory device that stores program code configured to be executed by the processor, the program code comprising:
a resource manager configured to:
receive a request by an entity for virtual machine (VM) allocation, the request comprising a number of VMs, a first priority VM type, and a second priority VM type;
provision the request for VM allocation with available VMs of the first priority VM type;
determine a capacity shortage of VMs of the first priority VM type to fulfill the request for VM allocation; and
provision the request for VM allocation with available VMs of the second priority VM type.

2. The system of claim 1, the request further comprising a third priority VM type, the resource manager further configured to:
determine a capacity shortage of VMs of the first priority VM type and the second priority VM type to fulfill the request for VM allocation; and
provision the request for VM allocation with available VMs of the third priority VM type.

3. The system of claim 1, wherein the resource manager may be (e.g., further) configured to:
notify an entity providing the request about the provisioning of the request including a quantity of the first priority VM type and a quantity of the second priority VM type.

4. The system of claim 1, the request further comprising an indication of the first and second priority VMs in a first region or a first zone within the first region, the resource manager further configured to:
recommend to an entity providing the request available VMs of at least one of the first priority VM type or the second priority VM type in a second region or a second zone within the second region.

5. The system of claim 1, the request further comprising an indication of the first and second priority VMs in a first region or a first zone within the first region, the resource manager further configured to:
recommend to an entity providing the request available VMs of a third priority VM type in at least one of the first region, the first zone, a second region, or a second zone within the second region.

6. The system of claim 1, the program code further comprising:
a capacity analyzer configured to:
determine a past VM creation by an entity, including past compute capacity and a past timeframe;
predict a future request for VM creation by the entity, including predicted compute capacity and a predicted timeframe, based on the past VM creation;
predict a future compute capacity for at least one of a region or a zone within a region during at least the predicted timeframe; and
alert the entity if the predicted future compute capacity is less than the predicted compute capacity.

7. The system of claim 6, the capacity analyzer further configured to:
alert the entity about a future timeframe when the predicted compute capacity is equal to or greater than the future compute capacity.

8. The system of claim 6, the resource manager further configured to:
receive an indication that the entity participates in dynamic reservation of computing capacity for VM allocation;
reserve the predicted compute capacity at the predicted timeframe before the resource manager receives the request for VM allocation; and
provision the request for VM allocation with available VMs of the first or second priority VM types from the reserved compute capacity.

9. The system of claim 8, the resource manager further configured to:
release the reserved predicted compute capacity at the predicted timeframe if the request for VM allocation is not received within a time threshold based on a start time of the predicted timeframe.

10. The system of claim 8, wherein the reservation is automatic based on a prediction by the capacity analyzer that the future compute capacity will be less than the predicted compute capacity without the reservation.

11. A method comprising:
receiving a request for virtual machine (VM) allocation for an entity, the request comprising a number of VMs, a first priority VM type, and a second priority VM type;
provisioning the request for VM allocation with available VMs of the first priority VM type;
determining a capacity shortage of VMs of the first priority VM type to fulfill the request for VM allocation; and
provisioning the request for VM allocation with available VMs of the second priority VM type based on the capacity shortage.

12. The method of claim 11, wherein the request further comprises an indication of the first and second priority VMs in a first region or a first zone within the first region, the method further comprising:
recommending to an entity providing the request available VMs of at least one of the first priority VM type or the second priority VM type in a second region or a second zone within the second region.

13. The method of claim 11, wherein the request further comprises an indication of the first and second priority VMs in a first region or a first zone within the first region, the method further comprising:
recommending to an entity providing the request available VMs of a third priority VM type in at least one of the first region, the first zone, a second region, or a second zone within the second region.

14. The method of claim 11, further comprising:
determining a past VM creation by an entity, including past compute capacity and a past timeframe;
predicting a future request for VM creation by the entity, including a predicted request compute capacity and a predicted request timeframe, based on the past VM creation;
predicting a future compute capacity for at least one of a region or a zone within a region during at least the predicted request timeframe; and
alerting the entity if the predicted future compute capacity is less than the predicted request compute capacity for the predicted request timeframe.

15. The method of claim 14, further comprising:
receiving an indication that the entity participates in dynamic reservation of computing capacity for VM allocation;
reserving the predicted request compute capacity at the predicted request timeframe before the resource manager receives the request for VM allocation; and
provisioning the request for VM allocation with available VMs of the first or second priority VM types from the reserved compute capacity if the request for VM allocation is received within a time threshold based on a start time of the predicted timeframe.

16. The method of claim 15, further comprising:
releasing the reserved predicted request compute capacity at the predicted timeframe if the request for VM allocation is not received within a time threshold based on a start time of the predicted timeframe.

17. A computer-readable storage medium having program instructions recorded thereon that, when executed by a processor, implements a method comprising:
receiving a request for virtual machine (VM) allocation for an entity, the request comprising a number of VMs, a first priority VM type, and a second priority VM type;
provisioning the request for VM allocation with available VMs of the first priority VM type;
determining a capacity shortage of VMs of the first priority VM type to fulfill the request for VM allocation; and
provisioning the request for VM allocation with available VMs of the second priority VM type based on the capacity shortage.

18. The computer-readable storage medium of claim 17, wherein the request further comprises an indication of the first and second priority VMs in a first region or a first zone within the first region, the method further comprising:
recommending to an entity providing the request available VMs of at least one of the first priority VM type or the second priority VM type in a second region or a second zone within the second region; or
recommending to an entity providing the request available VMs of a third priority VM type in at least one of the first region, the first zone, a second region, or a second zone within the second region.

19. The computer-readable storage medium of claim 17, wherein the method further comprises:
determining a past VM creation by an entity, including past compute capacity and a past timeframe;
predicting a future request for VM creation by the entity, including a predicted request compute capacity and a predicted timeframe, based on the past VM creation;
predicting a future compute capacity for at least one of a region or a zone within a region during at least the predicted timeframe; and
alerting the entity if the predicted future compute capacity is less than the predicted request compute capacity.

20. The computer-readable storage medium of claim 17, wherein the method further comprises:
receiving an indication that the entity participates in dynamic reservation of computing capacity for VM allocation;
reserving the predicted request compute capacity at the predicted request timeframe before the resource manager receives the request for VM allocation; and
provisioning the request for VM allocation with available VMs of the first or second priority VM types from the reserved predicted request compute capacity.
